(19) United States
(12) Patent Application Publication
(10) Pub. No.: US 2007/0041327 A1
(43) Pub. Date: Feb. 22, 2007

(54) Multicast heartbeat signaling

(75) Inventors: William Foster, Nanaimo (CA); Leo Nieuwesteeg, Plano, TX (US); Flemming Andreasen, Marlboro, NJ (US); David McDaniel, Dallas, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Cisco Technology, Inc., San Jose, CA (US)

(21) Appl. No.: 11/204,964

(22) Filed: Aug. 16, 2005

(51) Int. Cl. G06F 11/00; H04J 3/14

(52) U.S. Cl. 370/242; 370/218; 714/1

(57) ABSTRACT

A mechanism that provides for communication of heartbeat signals from servers (call agents) to clients (gateways) in a packet telephony network environment. Clients listen for receipt of multicast heartbeats from any of the servers that may be part of a multicast group. A client assigned to a particular server for control messaging, upon failure to receive a response to a message sent to the assigned server and failure to receive a heartbeat from the assigned server, may select a second server from among the servers and re-send the message to the second server. Without receipt of heartbeat signals, the client defaults to a normal retry behavior for re-sending the message first to the assigned server a number of times before attempting to re-send the message to the second server. With receipt of the heartbeat from the second server, the client adopts an aggressive retry behavior by re-sending the message to the assigned server a lesser number of retries before attempting to re-send the message to the second server. The clients use the multicast heartbeats as a hint, allowing them to switch to the more aggressive retry behavior and consequently reduce the time to re-associate with a new server and re-establish a new security association (if IPsec is used), resulting in a drastic reduction in service delay due to server failures.

### BACKGROUND

In packet telephony or Voice over Internet Protocol (VoIP) networks, there are several protocol stacks that have been defined to facilitate the provision of voice, video and other messaging services. These protocol stacks include H.323, Session Initiation Protocol (SIP), Media Gateway Control Protocol (MGCP) and others.

The MGCP protocol, defined under Internet Standard RFC 3435 (F. Andreasen, B. Foster, “Media Gateway Control Protocol (MGCP) Version 1.0”, RFC 3435, January 2003), is suited for centralized systems controlling IP telephony gateways that operate with endpoints having little or no intelligence, such as analog telephones. MGCP is a plain-text, master/slave protocol that allows call control devices, also referred to as call agents or more generally as servers, to take control of a specific port on a gateway or on an MGCP-controlled IP phone, also referred to more generally as a client or MGCP endpoint. MGCP messages between call agents and MGCP endpoints are sent with Internet Protocol over User Datagram Protocol (IP/UDP). No voice data is transmitted through the MGCP protocol itself. Rather, all the voice data transfer occurs directly between the gateways.

PacketCable is an industry-wide initiative for developing interoperability standards for multimedia services over cable facilities using packet technology. PacketCable developed protocols called Network-based Call Signaling (NCS) and Trunking Gateway Control Protocol (TGCP), which both contain extensions and modifications to MGCP while preserving basic MGCP architecture and constructs. NCS is designed for use with analog, single-line user equipment on residential gateways, while TGCP is intended for use in VoIP-to-PSTN trunking gateways in a cable environment. Hereinafter, references to MGCP are defined to include NCS/TGCP unless otherwise noted.

RFC 3435 defines procedures for use in the case of failure of a server (Call Agent) that has been assigned (referred to as “NotifiedEntity”) to a client. In particular, upon a client failing to receive an acknowledgment or response to an MGCP message, the procedures provide for the client to attempt to re-send the MGCP message to an address for the assigned server a number of times before deciding to begin sending the MGCP message to another address on the same or a different server. However, because of the timing required for re-sending, this so-called retry behavior upon failover can still result in significant service delays.

Some voice applications require security. One security mechanism that provides authentication or encryption is the Internet Protocol security or IPsec mechanism (S. Kent, R. Atkinson, “Security Architecture for the Internet Protocol”, RFC 2401, November 1998). In the MGCP context, IPsec operates under the MGCP layer to permit data transport by setting up a security association between two devices that are using MGCP (e.g., between a call agent server and a client). Upon failure of an interface or a failover of a server, service delays may increase if the client is unaware that its security association is no longer valid.

Techniques to resolve the security association problem require either trying to maintain security associations across failovers or maintaining multiple security associations. These approaches can be quite complex, and still do not reduce the service delay due to MGCP retries when a server or interface fails. The retry mechanisms associated with an interface failure and a server failure are similar, and we will henceforth simply refer to server failures.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a network configuration that illustrates principles of the present approach.

FIG. 2 is a call flow diagram that illustrates one type of communication between a client and a primary/backup server pair without the benefit of the present approach.

FIG. 3 is a call flow diagram that illustrates one type of communication between a client and a primary/backup server pair with the benefit of the present approach.

FIG. 4 is a call flow diagram that illustrates one type of communication between a client and plural servers with the benefit of the present approach.

FIG. 5 is a call flow diagram that illustrates a second type of communication between a client and a primary/backup server pair without the benefit of the present approach.

FIG. 6 is a call flow diagram that illustrates a second type of communication between a client and a primary/backup server pair with the benefit of the present approach.

FIG. 7 is a diagram that illustrates a process flow for a client in accordance with the present approach.

FIG. 8 illustrates a sample format for a heartbeat packet.

FIG. 9 illustrates a high-level partial schematic block diagram of a first embodiment of a gateway client.

FIG. 10 illustrates a high-level partial schematic block diagram of a second embodiment of a gateway client.

FIG. 11 illustrates a high-level partial schematic block diagram of an embodiment of an IP phone client.

FIG. 12 illustrates a high-level partial schematic block diagram of an embodiment of a call agent server.

### DETAILED DESCRIPTION

The present approach is directed to a mechanism that provides for communication of heartbeat signals from servers to clients in a packet telephony network environment. The servers may be call agents and the clients may be gateways or MGCP-controlled IP phones. In one embodiment, clients listen for receipt of multicast heartbeats from any of the servers that may be part of a multicast group. A client assigned to a particular server for control messaging, upon failure to receive a response to a message sent to the assigned server and failure to receive a heartbeat from the assigned server, may select a second server from among the servers and re-send the message to the second server. Without receipt of any heartbeat signals, the client defaults to a normal retry behavior for re-sending the message first to the assigned server a number of times before attempting to re-send the message to the second server. However, with the present approach based on receipt of the heartbeat from the second server, the client adopts an aggressive retry behavior by, for example, re-sending the message to the assigned server a lesser number of retries before attempting to re-send the message to the second server. The clients use the multicast heartbeats as a hint, allowing them to switch to the more aggressive retry behavior and consequently reduce the time to re-associate with a new server and re-establish a new security association (if IPsec is used). An advantage of this approach is a drastic reduction in service delay due to server failures.

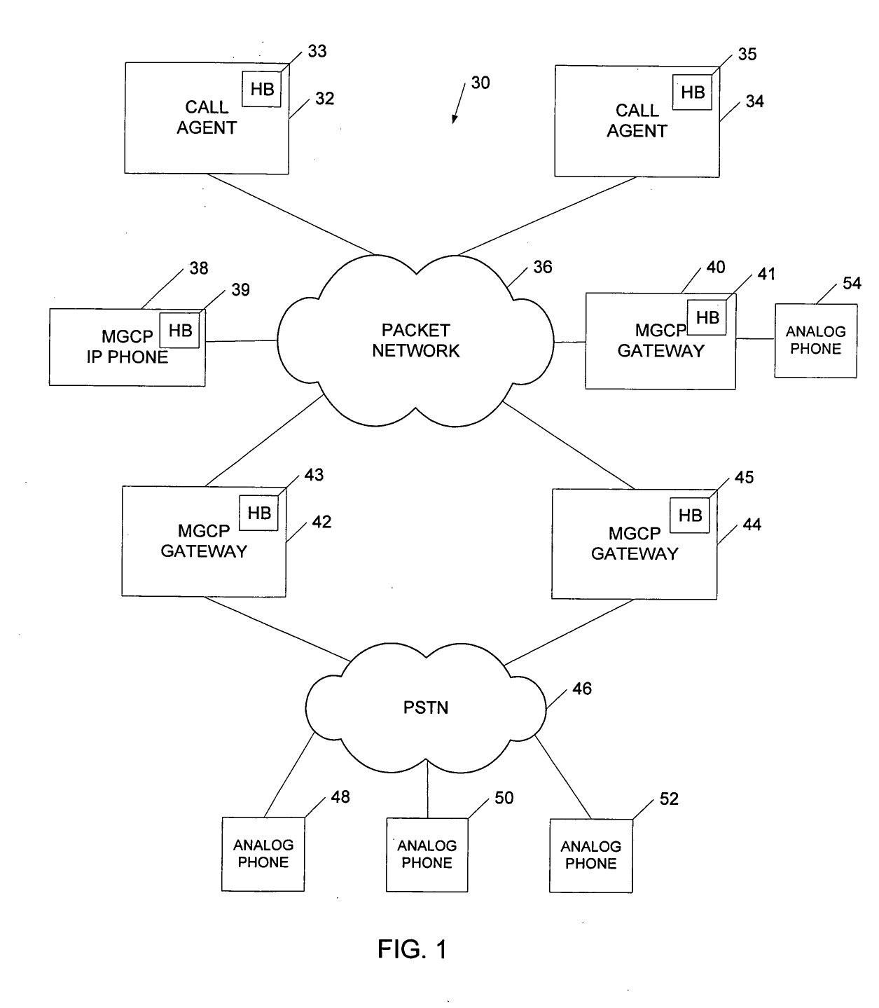

Referring to FIG. 1, an exemplary network configuration 30 illustrates principles of the present approach. The network configuration includes call agents 32, 34, IP phone 38, and MGCP gateways 40, 42, 44 coupled to packet network 36. The gateways 42, 44 are also coupled to public switched telephone network (PSTN) 46. Analog phones 48, 50, 52 are coupled to the PSTN 46. Analog phone 54 is connected to gateway 40.

The packet network 36 may be implemented as a local area network (LAN), wide area network (WAN), global distributed network such as the Internet, Intranet, Extranet or any other form of wireline or wireless communication network. Generally, the network 36 may include any number and combination of routers, hubs, switches, gateways, call agents, endpoints, or other hardware and software, for the communication of packets or other portions of information and control between network components (e.g., call agents, IP phones, MGCP gateways).

In a particular embodiment, network 36 employs voice communication protocols that allow for the addressing or identification of network components coupled to the network 36. For example, using Internet protocol (IP), each of the components coupled together by communication network 36 may be identified in information directed using IP addresses. In this manner, network 36 may support any form and/or combination of point-to-point, multicast, unicast, or other techniques for exchanging media packets among components in communication system 30. Any network components capable of exchanging audio, video, or other data using frames or packets, are included within the scope of the present approach.

Packet network 36 may be directly coupled to other IP networks including, but not limited to, another LAN, or the Internet. In addition to being coupled to other IP networks, network 36 may also be coupled to non-IP telecommunication networks through the use of interfaces or components, for example gateways 42, 44. In the illustrated embodiment, packet network 36 is coupled with PSTN 46 through gateways 42, 44. PSTN 46 may include switches, central offices, mobile telephone switching offices, pager switching offices, remote terminals, and other related telecommunications equipment.

Technology that allows telecommunications to be transmitted over an IP network may comprise Voice over IP (VoIP), or simply Voice over Packet (Vop). In the illustrated embodiment, IP phone 38, and gateways 40, 42, 44 are IP telephony devices. IP telephony devices have the ability of encapsulating a user's voice information (or other input) into IP packets so that the voice can be transmitted over network 36. IP telephony devices may include telephones, fax machines, computers running telephony software, nodes, gateways, or any other devices capable of performing telephony functions over an IP network. The call agents 32, 34 communicate with the MGCP gateways 40, 42, 44 and IP phone 38 using MGCP messaging to control the transfer of voice packets between IP phone 38, and gateways 40, 42 and 44. This allows users of IP phone 38 and analog phones 48, 50, 52 and 54 to communicate with each other.

Although FIG. 1 illustrates a particular number and configuration of call agents, gateways, IP phones and analog phones, the communication system 30 contemplates any number or arrangement of such components for communicating media. In addition, the system 30 contemplates arrangements that operate based on NCS for packet cable configurations using media termination adapters (MTAs) illustrated in FIG. 1 as gateway 40.

In accordance with the present approach, the call agents 32, 34 in the illustrated embodiment include heartbeat transmission component 33, 35 that communicates heartbeat signals to IP phone 38 and the gateways 40, 42, 44. The IP phone 38 and gateways 40, 42, 44 in the illustrated embodiment include heartbeat reception component 39, 41, 43, 45 for processing heartbeat signals in accordance with the present approach. The functionality provided by the heartbeat components in the call agents and gateways is described further herein.

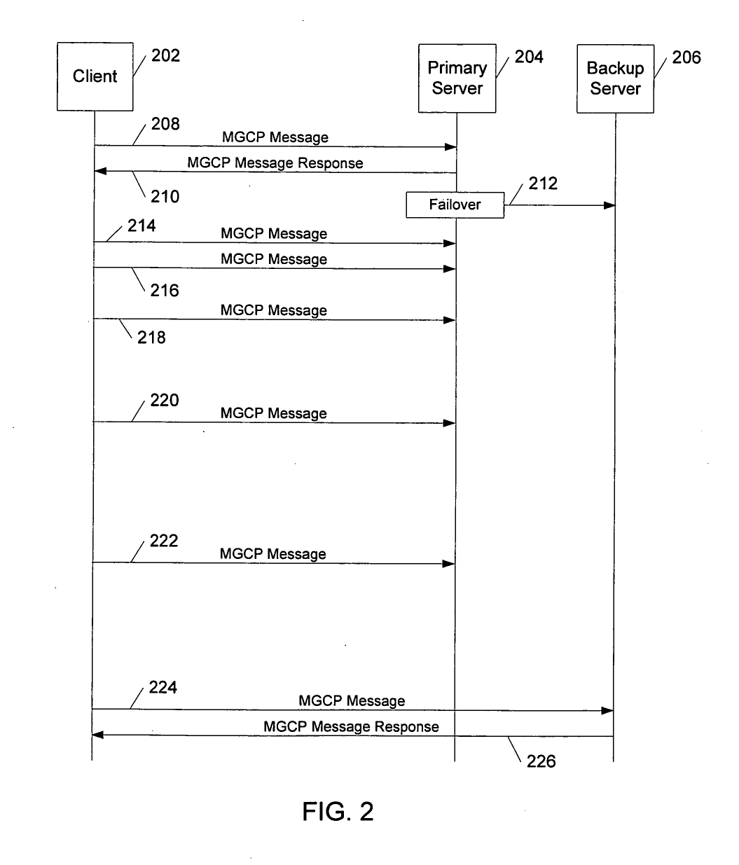

FIG. 2 illustrates one type of communication between a client and a primary/backup server pair without the benefit of the heartbeat signaling of the present approach. In this scenario, a client 202 under normal conditions has sent an MGCP message 208 to primary server 204, and the client has received a response 210 from the primary server. Subsequently, a failover 212 of the primary server 204 occurs. The number of retries by the client to communicate with the primary server is normally configurable and typically may be set to a value of 4 or 5. In order to prevent overloading, retry times or intervals are doubled with each retry (as defined by MGCP/NCS). For example, with a retry time interval configured to 200 ms and the number of retries set to 4, a message 214 happens to be sent to the primary server 204 subsequent to the failover. Since no response is received from the failed primary server, a first retry is made at 216 after 200 ms. After an additional 400 ms, the second retry occurs at 218. After an additional 800 ms, the third retry is made at 220. The fourth retry is made after an additional 1600 ms at 222. Finally, after another 3200 ms, the client sends the retry at 224 to the backup server 206, and the backup server responds at 226 In this illustrated example, the total amount of time spent in trying to communicate the MGCP message is 6.2 seconds plus the response time from the backup server (typically less than 100 ms).

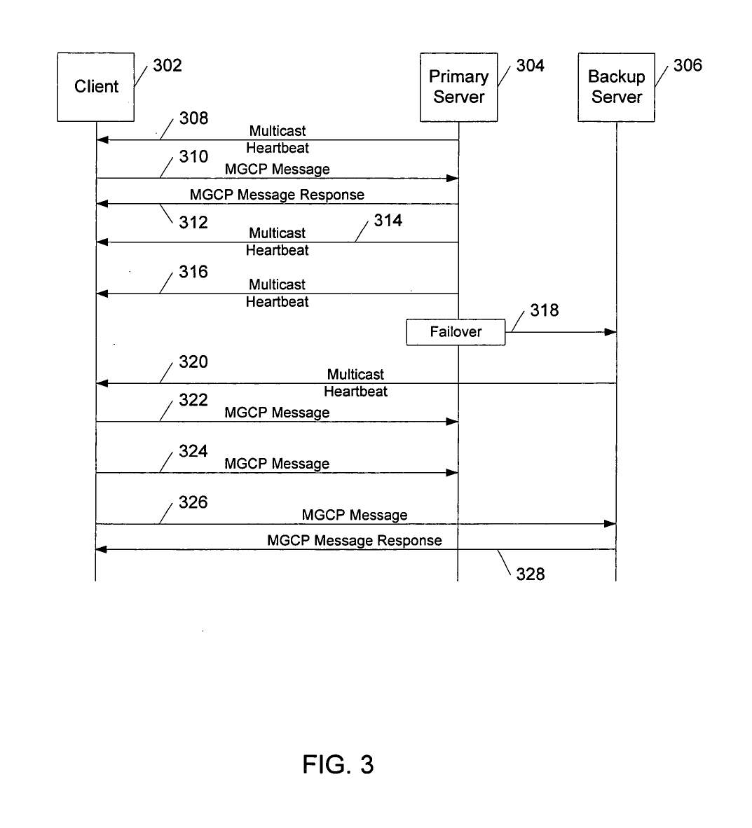

FIG. 3 illustrates improved communication relative to the scenario of FIG. 2 based on the benefits of the heartbeat signaling of the present approach. In particular, a heartbeat 308, 314, 316 is periodically sent from the primary server 304 to a multicast address of a multicast group that includes the client 302. In this scenario, under normal active conditions of the primary server 304, an MGCP message 310 sent by the client to the IP address of the primary server 304 is acknowledged with response 312. Subsequently, a failover 318 of the primary server 304 occurs. Upon the failover, backup server 306 starts periodically (e.g., every few hundred milliseconds) sending multicast heartbeats 320 (subsequent heartbeat signals sent from the backup server are not shown in order to simplify the diagram). Since the client 302 is able to detect the multicast heartbeats, it modifies the retry behavior from that of FIG. 2 to a more aggressive behavior. In particular, the more aggressive behavior may include, for example, a reduced number of retries (e.g., 0, 1 or 2 retries rather than 4 or 5) and no doubling or other increase in the retry time or interval. Thus, as shown in FIG. 3, an MGCP message 322 sent to the primary server 304 after the failover and subsequent detection of the heartbeat from the backup server is followed by a retry 324 to the primary server after 200 ms. Rather than retrying several more times at increasing time intervals, the client following the aggressive approach (configured in this example to retries =1) next sends the retry 326 to the backup server 306 after another 200 ms. With this aggressive approach, the total amount of time spent is reduced to, in this example, 400 ms plus the response time of the backup server (again, typically less than 100 ms). The reduction from about 6.2 seconds to about 400 ms between the two example scenarios (FIG. 2, FIG. 3) is a significant improvement in terms of reducing service delay to users.

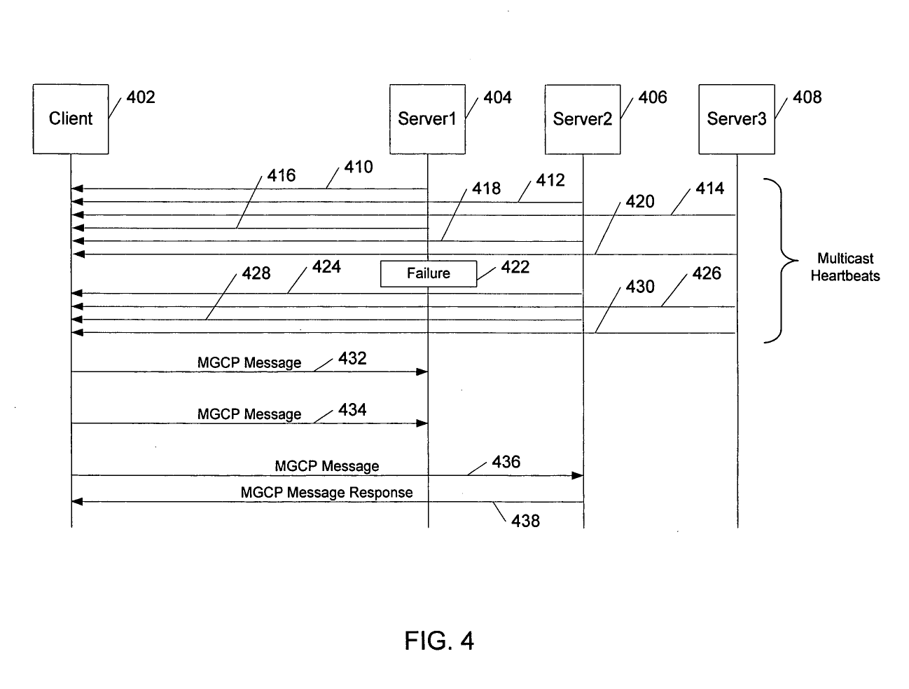

Referring to FIG. 4, a call flow is shown that illustrates the benefits of the present approach in relation to communication between a client 402 and plural servers (server1 404, server2 406, server3 408). In this example scenario, rather than a primary/backup server arrangement, there are three active servers 404, 406, 408. The active servers all may send heartbeat signals 410, 412, 414, 416, 418, 420 to the multicast address of the multicast group that includes the client 402. The subsequent disappearance of one of the heartbeat signals among the other heartbeats 424, 426, 428, 430 as detected at the client 402 indicates the possible failover 422 of server1 404. Based on the detection of heartbeat signals, similar to that described above for FIG. 3, the client 402 modifies its retry behavior to a more aggressive retry behavior, e.g., reduced number of retries (e.g., 0, 1 or 2 retries rather than 4 or 5) and no doubling or other increase in the retry time or interval. Thus, as shown in FIG. 4, an MGCP message 432 sent to server1 404 after the failover 422 is followed by a retry 434 to server1 404 after 200 ms. Rather than retrying several more times at increasing time intervals, the client following the aggressive approach (configured in this example to retries =1) next sends the retry 436 to one of the other servers (server2 406 or server3 408) after another 200 ms. With this aggressive approach, the total amount of time spent is again reduced to, in this example, 400 ms plus the response time of the other server (again, typically less than 100 ms).

In the case of several servers being active and available as illustrated in FIG. 4, the client may select server2 406 or server3 408 based on server preference or loading information indicated in the payload of the multicast heartbeat as described further herein.

Thus, it can be seen that with the present approach as described with respect to FIGS. 3 and 4, a client that has not received a response to a message sent to an assigned server modifies it retry behavior based on the recent history of heartbeats received. The client may modify its retry behavior if it has stopped receiving heartbeats from the assigned server and it is receiving heartbeats from another server to which it can failover. Otherwise, if the client is still receiving heartbeats from its assigned server or is not receiving heartbeats from any server, then the server will not modify its retry behavior.

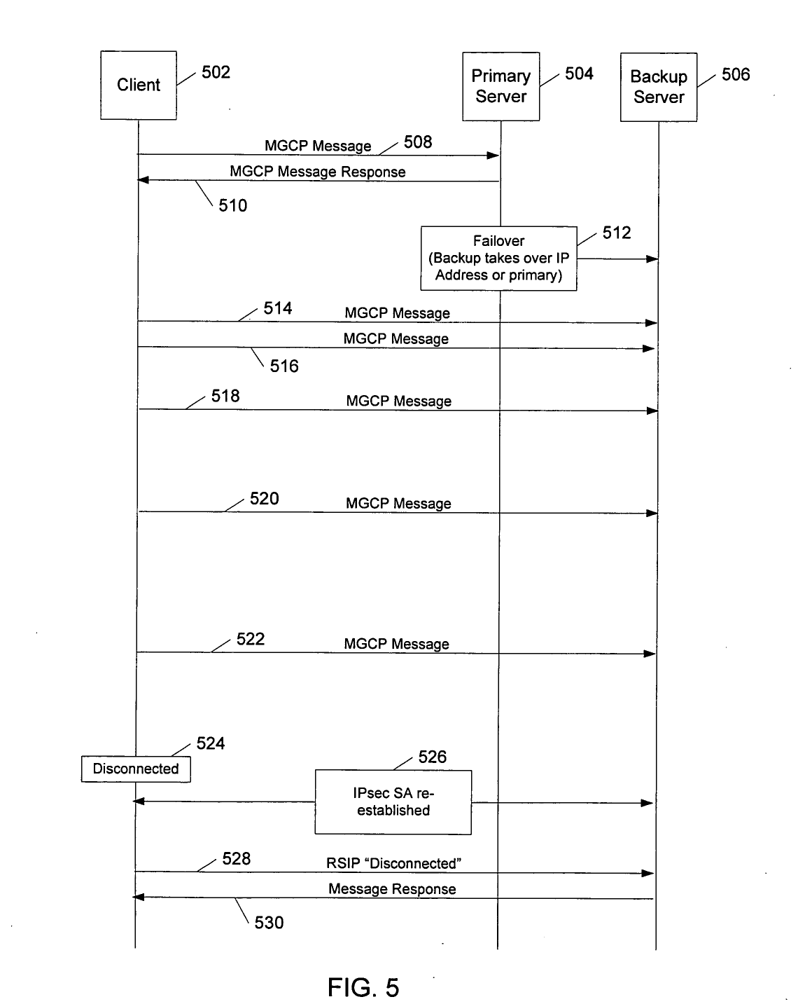

FIG. 5 is a diagram that illustrates a second type of communication that uses IPsec security association between a client and a primary/backup server pair without the benefit of the heartbeat signaling of the present approach. In this example scenario, a client 502 under normal conditions has sent an MGCP message 508 to primary server 504, and the client has received a response 510 from the primary server. Subsequently, a failover 512 of the primary server 504 occurs. After the failover, backup server 506 takes over the IP address of the primary server, but does not take over the IPsec security association. The client 502 does not detect that the security association is no longer operational or that a failover has occurred. The MGCP messages sent from the client to the IP address of the primary server 504 now are received at the backup server 506. However, since there is not a valid IPsec security association between the client 502 and the backup server 506, the backup server 506 drops the received messages at the IPsec layer. It is not until after the client 502 proceeds through the normal retry behavior (i.e., messages 514, 516, 520, 522 sent 4 times at retry time intervals that are doubled similar to FIG. 3) and the client enters a “disconnected” state 524 that the client tries to negotiate or establish IPsec security association with the backup server 506. Once the IPsec security association is established at 526, the MGCP/NCS application layer at the backup server 506 can see the messages from the client and respond. In this case, since there was a disconnected state at the client, the client sends an RSIP “Disconnected” message 528 that is acknowledged with a response 530. In this illustrated example, given an initial retry interval of 200 ms, the total amount of time spent in trying to communicate the MGCP message is the cumulative retry time of 6.2 seconds, plus the time to re-establish IPsec security association (typically less than 100 ms) and the response time from the backup server (typically less than 100 ms).

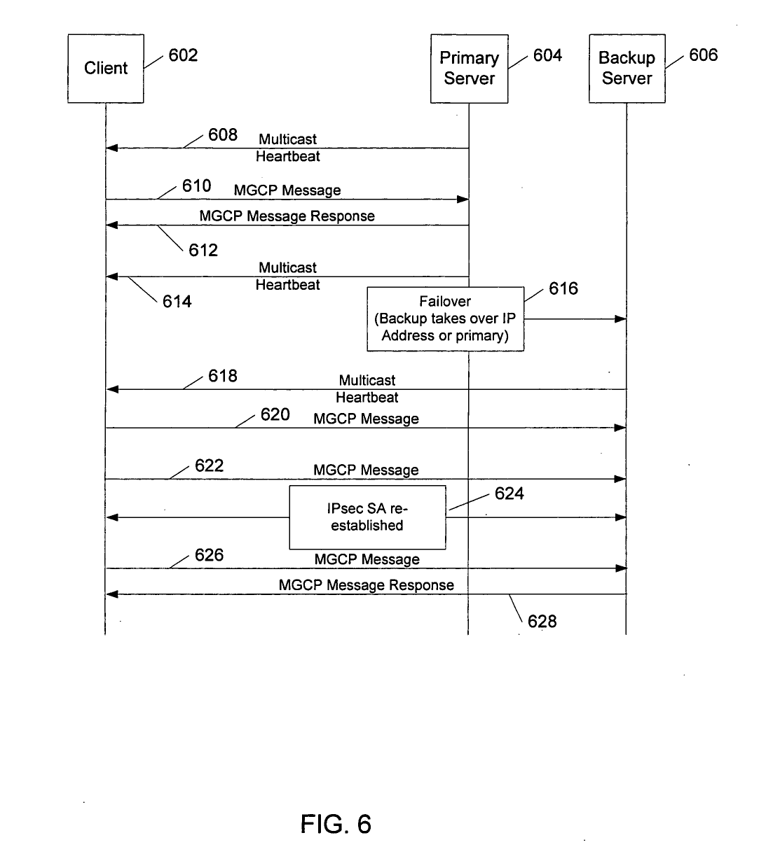

FIG. 6 illustrates improved communication relative to the scenario of FIG. 5 based on the benefits of the heartbeat signaling of the present approach. In particular, a heartbeat 608, 614 is periodically sent from the primary server 604 to the multicast address of the multicast group that includes the client 602. In this example scenario, under normal active conditions of the primary server 604, an MGCP message 610 sent by the client to the IP address of the primary server 604 is acknowledged with response 612. Subsequently, a failover 616 of the primary server 604 occurs. After the failover, backup server 606 takes over the IP address of the primary server, but does not take over the IPsec security association. The client 602 at first does not detect that the security association is no longer operational or that a failover has occurred. Upon the failover, backup server 606 starts periodically sending multicast heartbeats 618 (subsequent heartbeat signals sent from the backup server are not shown in order to simplify the diagram). In one embodiment, even though the heartbeat signals received at the client 602 have the same source IP address as the primary server 604 had, the client 602 is able to determine that the heartbeats are coming from the backup server 606 based on a server identifier indicated in the payload of the multicast heartbeat as described further herein.

Since the client 602 is able to detect that the multicast heartbeats are now coming from the backup server 606, it modifies the retry behavior from that of FIG. 5 to a more aggressive behavior. In particular, the more aggressive behavior may include a reduced number of retries (e.g., 1 or 2 retries rather than 4 or 5) and no doubling or other increase in the retry time or interval. Thus, as shown in FIG. 6, an MGCP message 620 sent to the IP address of the primary server 604 (now taken over by the backup server 606) after the failover and subsequent detection of the heartbeat from the backup server is followed by a retry 622 to the IP address of the primary server after 200 ms. Rather than retrying several more times at increasing time intervals, the client following the aggressive approach (configured in this example to retries =1) next re-negotiates or re-establishes IPsec security association with the backup server 606 after another 200 ms. Once the IPsec security association is established at 624, the MGCP/NCS application layer at the backup server 606 can see the message 626 from the client and send a response 628. With this aggressive approach, the total amount of time spent is reduced to, in this example, 400 ms plus the time to re-establish IPsec security association (typically less than 100 ms) and the response time of the backup server (again, typically less than 100 ms). The reduction from over 6.2 seconds to less than 600 ms between the two scenarios (FIG. 5, FIG. 6) is a significant improvement in terms of reducing service delay to users that employ IPsec.

In the foregoing examples, clients 302, 402, 602 may correspond to MGCP IP phone 38 and gateways 40, 42, 44 with heartbeat components 39, 41, 43, 45 and the servers 304, 306, 404, 406, 408, 604, 606 may correspond to call agents 32, 34 with heartbeat components 33, 35.

It should be noted that, while the aggressive retry behavior may be configured to set retries to a value of 0, i.e., no retries before attempting to communicate with an alternate server, having zero retries may be too aggressive. That is because there may be some transient problem with multicast or network portioning that could cause thrashing. Thus, setting the retry value to at least 1 or 2 as opposed to 0 is more reasonable.

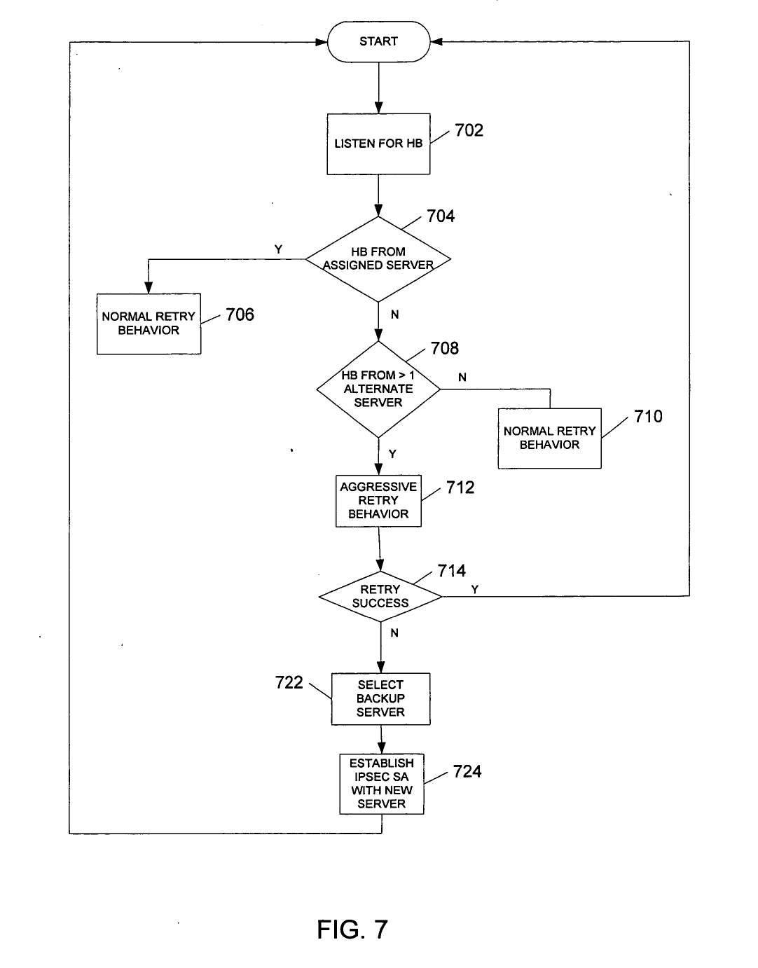

FIG. 7 illustrates a process flow for the clients 302, 402, 602. At the start of the process, the client listens for heartbeats at 702. A client determines which server it is obtaining the heartbeat from based on the source IP address of the heartbeat. In addition, it may make use of a server identifier in the payload of the heartbeat message to help identify the server.

At 704, if heartbeats are received from it's assigned server, normal retry behavior is maintained at 706. If no heartbeats are detected at 704, and no heartbeats are detected from alternative servers at 708, then normal retry behavior is maintained at 710.

However, if no heartbeats are received from its normal server at 704 but heartbeats are received from an alternative server at 708, the client switches to aggressive retry behavior at 712. If a retry to the normal server is successful at 714 the client keeps its association with the existing server. Otherwise it selects a backup server at 722. If the client is receiving heartbeats from more than one alternate server at 708, then the client may select at 722 among the alternate servers based on preference information indicated in the payload of the heartbeats. Note that if IPsec is used, the client will establish a security association with the new server at 724 before attempting to communicate with that server. That server then becomes the newly “assigned” server and the process continues.

There are several advantages to adopting the present approach. Although the multicast heartbeat is sent in the clear (not secured by a security protocol), because it is only used as a hint (i.e., the client checks to see if the hint is correct when it invokes its more aggressive retry behavior), it is still able to have a significant impact on reducing service delays even in an environment where false multicast emissions could occur. Using multicast allows heartbeats to be sent to all clients with very short periods (e.g., 100 ms) allowing clients to make decisions very rapidly (e.g., less than 1 second).

Another advantage is that heartbeat signaling in accordance with the present approach does not have to be supported by all clients. Clients that support the heartbeat signaling will see reduced service delays. Those that do not support it will simply experience the range of normal service delays that would have occurred without the heartbeat being available.

Similarly, the only impact of failures in the multicast heartbeat is reversion to normal service delays due to failovers. In other words, the heartbeat is an optimization, which if it fails for some reason, will result in communication being no worse than it was without the heartbeat.

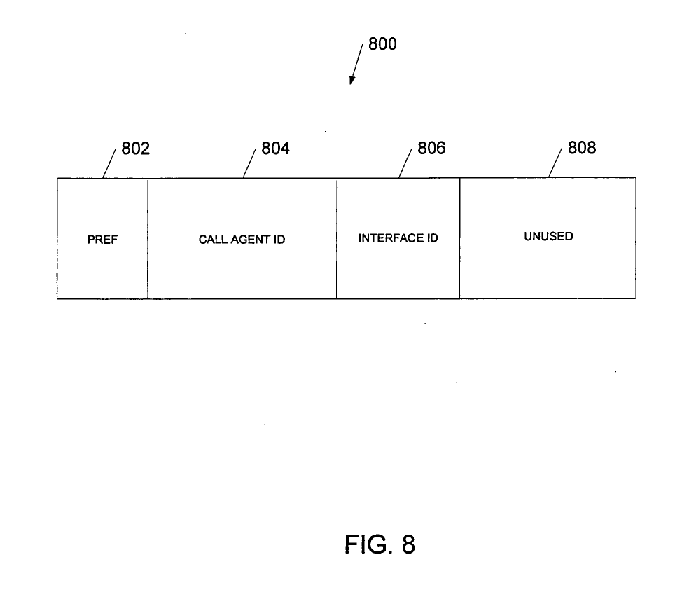

As noted in the description above, embodiments of the heartbeat may be defined to include a payload that contains a preference value and a server identifier; other parameters may be included as well. An illustrative example format for an embodiment of the heartbeat is shown in FIG. 8.

In one embodiment, the heartbeat is a UDP packet with a 4 byte payload 800. The 4 byte payload consists of a 4 bit preference value 802, a 16 bit Call Agent identifier 804, a 4 bit interface identifier 806 and an 8 bit unused field 808. If these fields are not used, they are set to zero. The Call Agent will normally be identified by the source IP address of the message (Call Agent identifier in the payload is not required and is set to zero). The Call Agent identifier may be used if for some reason the Call Agent sending the multicast message cannot be completely identified by means of the source IP address of the message. One example is where a backup Call Agent takes over the same IP address as its primary (i.e., use of a virtual IP address). Likewise, the interface identifier may be used to identify the particular interface on the Call Agent.

The 4 bit preference value (lower values, higher preference) may be used by a Call Agent to indicate its preference for a new endpoint to associate with it. For example, this could be resource (e.g., processor) loading value so that an endpoint would try to associate with a Call Agent that is least loaded. This would be used by a gateway when it is considering re-associating with a different Call Agent. It can use this preference value in the multicast payload when it has a list of addresses that otherwise have equal weight as far as the list of potential call agent candidates to associate with (e.g., notified entity or item on a notified entity list).

Configurable parameters on the Call Agent may include the multicast address of the heartbeat and the time between heartbeats (e.g., 300 ms). Configurable parameters on the may include the multicast address of the heartbeat; a Boolean to turn this behavior on or off for the gateway; and the number of retries MaxO for more aggressive retry behavior.

If the heartbeat is configured as being on, in one embodiment the gateway may attempt to join the multicast group after re-boot and listen to the heartbeat. Because there is no security associated with the heartbeat, the endpoint may assume that the heartbeat could be bogus. As such, it only takes the heartbeat as a hint to modify existing retry behavior.

The multicast heartbeat is sent by the collection of Call Agents that are able to provide service to the gateway at a given point in time. A gateway that has a list of possible Call Agent candidates (i.e., as defined by a notified entity or notified entity list) may also look at the heartbeats to obtain a hint as to the likelihood of contacting a particular Call Agent.

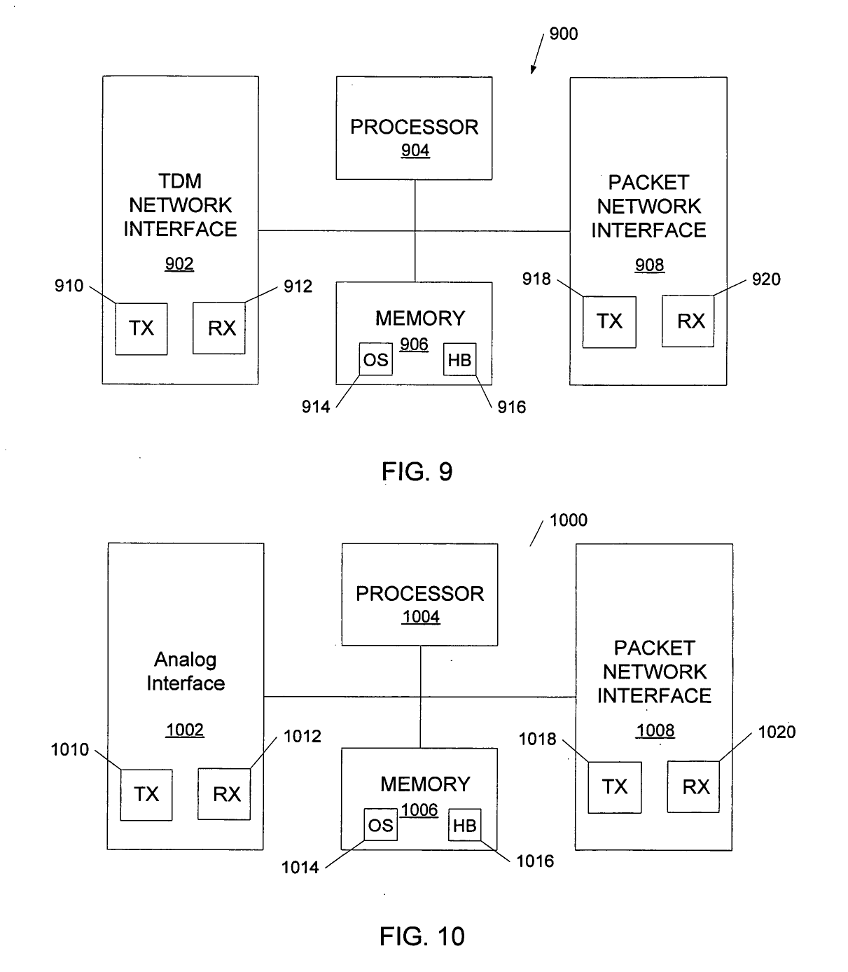

FIG. 9 illustrates a high-level partial schematic block diagram of a first embodiment of a gateway client 900 that may be used with the present invention. Gateway client 900 includes a time division multiplex (TDM) network interface module 902 and a packet network interface module 908. The network interface module 902 interconnects the gateway client 900 with the public switched telephone network (e.g., PSTN 46 shown in FIG. 1) and enables the gateway client 900 to communicate with other components in the PSTN. To that end, module 902 comprises conventional interface circuitry that incorporates signal, electrical and mechanical characteristics, and interchange circuits, including transmitter 910 and receiver 912, needed to interface with the physical media of the PSTN and protocols running over that media.

Packet network interface module 908 interconnects the gateway client 900 with the packet network (e.g., packet network 36 shown in FIG. 1) and provides various functions that enable gateway client 900 to support various protocols, such as VoIP protocols including MGCP. To that end, module 908 contains transmitter and receiver circuitry 918, 920 respectively, needed to interface with the physical media of the packet network and protocols running over that media.

Processor 904 comprises logic and circuitry configured to execute software and manipulate (i.e., access and maintain) data structures contained in memory 906 in support of functions in accordance with the present invention.

Memory 906 is a computer-readable medium organized as a random-access memory (RAM) and implemented using various RAM devices, such as dynamic-random-access memory (DRAM) devices. The memory is configured to hold various computer executable instructions and data structures including computer executable instructions and data structures that implement aspects of the present invention. It should be noted that other computer readable mediums, such as disk units and flash memory, may be configured to hold computer readable instructions and data that implement aspects of the present invention. In addition, it should be noted that various electromagnetic signals may be encoded to carry instructions and data that implement aspects of the present invention on a data network.

Memory 906 includes an operating system 914 and a heartbeat reception component 916. The operating system 914 contains computer executable instructions and data configured to implement various conventional operating system functions that functionally organize the gateway client 900. Heartbeat reception component 916 contains computer executable instructions and data configured to enable processor 904 to perform functions that include processing heartbeat signals in accordance with the present approach.

FIG. 10 illustrates a high-level partial schematic block diagram of a second embodiment of a gateway client 1000 that may be used with the present invention. Gateway client 1000 includes an analog interface module 1002 and a packet network interface module 1008. The analog interface module 1002 interconnects the gateway client 1000 with analog phones (e.g., analog phone 54 shown in FIG. 1) and enables the gateway client 1000 to communicate with the analog phone. To that end, module 1002 comprises conventional interface circuitry that incorporates signal, electrical and mechanical characteristics, and interchange circuits, including transmitter 1010 and receiver 1012, needed to interface with the receiver and transmitter of the analog phone.

Packet network interface module 1008 interconnects the gateway client 1000 with the packet network (e.g., packet network 36 shown in FIG. 1) and provides various functions that enable gateway client 1000 to support various protocols, such as VoIP protocols including MGCP. To that end, module 1008 contains transmitter and receiver circuitry 1018, 1020 respectively, needed to interface with the physical media of the packet network and protocols running over that media.

Processor 1004 comprises logic and circuitry configured to execute software and manipulate (i.e., access and maintain) data structures contained in memory 1006 in support of functions in accordance with the present invention.

Memory 1006 is a computer-readable medium organized as RAM and implemented using various RAM devices, such as DRAM devices. The memory is configured to hold various computer executable instructions and data structures including computer executable instructions and data structures that implement aspects of the present invention. It should be noted that other computer readable mediums, such as disk units and flash memory, may be configured to hold computer readable instructions and data that implement aspects of the present invention. In addition, it should be noted that various electromagnetic signals may be encoded to carry instructions and data that implement aspects of the present invention on a data network.

Memory 1006 includes an operating system 1014 and a heartbeat reception component 1016. The operating system 1014 contains computer executable instructions and data configured to implement various conventional operating system functions that functionally organize the gateway client 1000. Heartbeat reception component 1016 contains computer executable instructions and data configured to enable processor 1004 to perform functions that include processing heartbeat signals in accordance with the present approach.

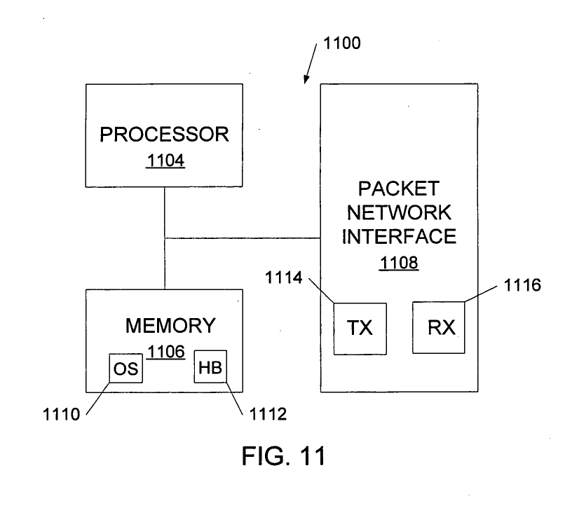

FIG. 11 illustrates a high-level partial schematic block diagram of an embodiment of an IP phone client 1100 that may be used with the present invention. IP client 1100 includes a packet network interface module 1108. Packet network interface module 1108 interconnects the IP phone client 1100 with the packet network (e.g., packet network 36 shown in FIG. 1) and provides various functions that enable IP phone client 1100 to support various protocols, such as VoIP protocols including MGCP. To that end, module 1108 contains transmitter and receiver circuitry 1114, 1116 respectively, needed to interface with the physical media of the packet network and protocols running over that media.

Processor 1104 comprises logic and circuitry configured to execute software and manipulate (i.e., access and maintain) data structures contained in memory 1106 in support of functions in accordance with the present invention.

Memory 1106 is a computer-readable medium organized as RAM and implemented using various RAM devices, such as DRAM devices. The memory is configured to hold various computer executable instructions and data structures including computer executable instructions and data structures that implement aspects of the present invention. It should be noted that other computer readable mediums, such as disk units and flash memory, may be configured to hold computer readable instructions and data that implement aspects of the present invention. In addition, it should be noted that various electromagnetic signals may be encoded to carry instructions and data that implement aspects of the present invention on a data network.

Memory 1106 includes an operating system 1110 and a heartbeat reception component 1112. The operating system 1110 contains computer executable instructions and data configured to implement various conventional operating system functions that functionally organize the IP phone client 1100. Heartbeat reception component 1112 contains computer executable instructions and data configured to enable processor 1104 to perform functions that include processing heartbeat signals in accordance with the present approach.

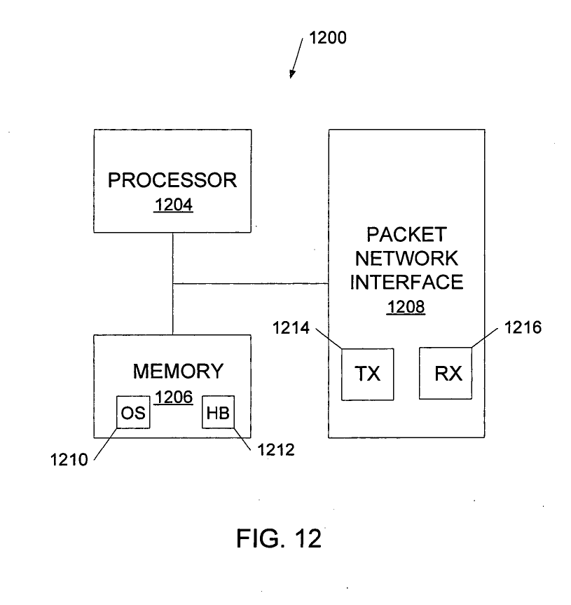

FIG. 12 illustrates a high-level partial schematic block diagram of an embodiment of a call agent server 1200. The call agent 1200 is configured to handle various call control functions associated with VoIP calls (e.g., made in packet network 36 shown in FIG. 1). Call agent 1200 includes a packet network interface module 1208. Packet network interface module 1208 interconnects the call agent 1200 with the packet network (e.g., packet network 36 shown in FIG. 1) and provides various functions that enable call agent 1200 to support various protocols, such as VoIP protocols including MGCP. To that end, module 1008 contains transmitter and receiver circuitry 1214, 1216 respectively, needed to interface with the physical media of the packet network and protocols running over that media.

Processor 1204 comprises logic and circuitry configured to execute software and manipulate (i.e., access and maintain) data structures contained in memory 1206 in support of functions in accordance with the present invention.

Memory 1206 is a computer-readable medium organized as RAM and implemented using various RAM devices, such as DRAM devices. The memory is configured to hold various computer executable instructions and data structures including computer executable instructions and data structures that implement aspects of the present invention. It should be noted that other computer readable mediums, such as disk units and flash memory, may be configured to hold computer readable instructions and data that implement aspects of the present invention. In addition, it should be noted that various electromagnetic signals may be encoded to carry instructions and data that implement aspects of the present invention on a data network.

Memory 1206 includes an operating system 1210 and a heartbeat transmission component 1212. The operating system 1210 contains computer executable instructions and data configured to implement various conventional operating system functions that functionally organize the call agent 1200. Heartbeat transmission component 1212 contains computer executable instructions and data configured to enable processor 1204 to perform functions that include communicating heartbeat signals in accordance with the present approach.

It should be noted that functions performed by embodiments that implement aspects of the present invention, may be implemented in whole or in part using some combination of hardware and/or software. It should be further noted that computer-executable instructions and/or computer data that implement aspects of the present invention may be stored in other computer-readable mediums, such as volatile memories, non-volatile memories, flash memories, removable disks, non-removable disks and the like. In addition, it should be noted that various electromagnetic signals, such as wireless signals, electrical signals carried over a wire, optical signals carried over optical fiber and the like, may be encoded to carry computer-executable instructions and/or computer data that implement aspects of the present invention on e.g., a data network.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of communication by a client over a network having plural servers, one of the servers assigned to receive messages from the client, the method comprising:
listening for receipt of multicast heartbeats from any of the servers;
sending a message to the assigned server;
upon failure to receive a response to the message sent to the assigned server and failure to receive a heartbeat from the assigned server, selecting a second server from among the servers and re-sending the message to the second server.

2. The method of claim 1 wherein each multicast heartbeat includes a payload having a preference value, and selecting includes:
selecting the second server based on the preference value.

3. The method of claim 2 wherein the preference value indicates relative loading of the corresponding server, and the client selects the least loaded server.

4. The method of claim 1 further including:
if a multicast heartbeat is received from at least one other server, re-sending the message to the assigned server up to a first number of retries before re-sending the message to the second server, otherwise re-sending the message to the assigned server up to a second number of retries before re-sending the message to the second server where the first number is less than the second number.

5. The method of claim 1 wherein the assigned server is a primary server and the second server is a backup server that sends multicast heartbeats upon failover of the primary server.

6. The method of claim 5 wherein the backup server takes over the virtual IP address of the primary server upon failover of the primary server.

7. The method of claim 6 wherein each multicast heartbeat includes a payload that includes a server identifier, and the client distinguishes the primary server from the backup server based on the server identifier.

8. The method of claim 1 wherein the client is a gateway or media termination adapter and the servers are call agents in a VoIP network.

9. A method of communication by a client over a network having a primary server and a backup server, the method comprising:
establishing IPsec security association between the client and the primary server;
listening for receipt of multicast heartbeats, each having a source IP address and a payload that includes a server identifier;
sending a message to the IP address of the primary server;
upon receipt of one or more multicast heartbeats having the same source IP address as the IP address of the primary server and the server identifier of the backup server, and failure to receive a response to the message sent to the IP address of the primary server, re-establishing IPsec security association between the client and the backup server.

10. The method of claim 9 further including:
re-sending the message to the IP address of the primary server up to a first number of retries before re-establishing IPsec security association.

11. The method of claim 9 further including:
re-sending the message to the IP address of the primary server after re-establishing IPsec security association.

12. The method of claim 9 wherein the client is a gateway or media termination adapter and the servers are call agents in a VoIP network.

13. A method of reducing service delay for a client over a network having a primary server and a backup server, the method comprising:
monitoring the status of the primary server at the backup server;
upon failover of the primary server,
starting transmission of multicast heartbeats from the backup server to the client; and
processing messages received from the client at the backup server.

14. The method of claim 13 further including taking over the virtual IP address of the primary server at the backup server upon failover, each multicast heartbeat including a server identifier to distinguish between the primary server and the backup server.

15. The method of claim 14 wherein failover of the primary server includes loss of IPsec security association between the primary server and the client, the method further including upon failover of the primary server:
re-establishing IPsec security association between the backup server and the client.

16. A method of reducing service delay for a client over a network having plural servers, one of the servers assigned to receive messages from the client, the method comprising:
sending multicast heartbeats from each of the servers to the client, each heartbeat including a preference value; and
upon failover of the assigned server, processing at one of the servers messages directed from the client based on the preference values.

17. The method of claim 16 wherein the preference value indicates relative loading of the corresponding server.

18. A client for communicating over a network having plural servers including an assigned server, the client comprising:
a receiver that receives multicast heartbeats from any of the servers;
a transmitter that sends a message to the assigned server;
a heartbeat reception component that selects a second server from among the servers based on a preference value in a payload of the received heartbeat, the transmitter re-sending the message to the second server upon failure to receive a response to the message sent to the assigned server and failure to receive a heartbeat from the assigned server.

19. The client of claim 18 wherein the preference value indicates relative loading of the corresponding server, and the client selects the least loaded server.

20. The client of claim 18 wherein if a multicast heartbeat is received from at least one other server, the transmitter re-sends the message to the assigned server up to a first number of retries before re-sending the message to the second server, otherwise re-sending the message to the assigned server up to a second number of retries before re-sending the message to the second server where the first number is less than the second number.

21. The client of claim 18 wherein the assigned server is a primary server and the second server is a backup server that sends multicast heartbeats upon failover of the primary server and wherein each multicast heartbeat includes a payload that includes a server identifier, and the client distinguishes the primary server from the backup server based on the server identifier.

22. The client of claim 18 wherein the client is a gateway or media termination adapter and the servers are call agents in a VoIP network.

23. Apparatus for communicating over a network having plural servers including an assigned server, the apparatus comprising:
means for listening for receipt of multicast heartbeats from any of the servers;
means for sending a message to the assigned server;
means for selecting a second server from among the servers and means for re-sending the message to the second server upon failure to receive a response to the message sent to the assigned server and failure to receive a heartbeat from the assigned server.

24. Apparatus for communicating over a network having a primary server and a backup server, the apparatus comprising:
means for establishing IPsec security association with the primary server;
means for listening for receipt of multicast heartbeats, each having a source IP address and a payload that includes a server identifier;
means for sending a message to the IP address of the primary server;
means for re-establishing IPsec security association with the backup server upon receipt of one or more multicast heartbeats having the same source IP address as the IP address of the primary server and the server identifier of the backup server, and failure to receive a response to the message sent to the IP address of the primary server.

25. Apparatus for reducing service delay in a network having a primary server and a backup server, the apparatus comprising:
means for monitoring the status of the primary server at the backup server;
means for starting transmission of multicast heartbeats from the backup server to the client and means for processing messages received from the client at the backup server upon failover of the primary server.

26. Apparatus for reducing service delay for a client over a network having plural servers, one of the servers assigned to receive messages from the client, the apparatus comprising:
means for sending multicast heartbeats from each of the servers to the client, each heartbeat including a preference value; and
means for processing at one of the servers messages directed from the client based on the preference values upon failover of the assigned server.

27. A server for reducing service delay for clients over a network, the server comprising:
a packet network interface for receiving messages from the clients; and
a heartbeat transmission component for sending multicast heartbeats periodically to the clients.

28. The server of claim 27 wherein the heartbeat comprises a payload that includes a server identifier and a preference value that indicates relative loading of the server.

29. The server of claim 27 wherein the server is a call agent in a VoIP network.

30. A backup server for reducing service delay for clients over a network that includes a primary server, the backup server comprising:
a heartbeat transmission component that sends multicast heartbeats periodically to the clients upon a failover of the primary server; and
a packet network interface for receiving messages from the clients.

31. The backup server of claim 30 wherein the heartbeat comprises a payload that includes a server identifier and a preference value that indicates relative loading of the backup server.

32. The backup server of claim 30 wherein the backup server is a call agent in a VoIP network.
